(19) United States
(12) Patent Application Publication
(10) Pub. No.: US 2021/0246674 A1
(43) Pub. Date: Aug. 12, 2021

(54) DOOR JAMB REPAIR KIT

(71) Applicant: William Hartung, Fort Myers, FL (US)

(72) Inventor: William Hartung, Fort Myers, FL (US)

(21) Appl. No.: 16/787,090

(22) Filed: Feb. 11, 2020

(51) Int. Cl. E04G 23/02; E06B 1/34

(52) U.S. Cl. CPC E04G 23/0277; E04G 23/0214; E06B 1/34

(57) ABSTRACT

A door jamb repair kit that includes: a sander; hinge plate covers; glue; filler; and a scraper to scrape the final finish in the doorjamb. The sander preferably includes a block sander.

### BACKGROUND OF THE INVENTION

### Field of Invention

The present invention is related to a kit that is configured to assist in the repair of a door jamb after hinges have been removed.

### Description of Related Art

Door jambs often need repair work where damage is incurred by the removal of hinges and the resulting exposed holes on the doorjamb. When the hinges are removed the door jamb is left with holes that need to be repaired to create a smooth surface. It would therefore be advantageous to have a complete kit to provide the necessary tools and materials to effectively repair the doorjamb.

### SUMMARY OF THE INVENTION

The present invention relates to a door jamb repair kit that includes: a sander; hinge plate covers; glue; filler; and a scraper to scrape the final finish in the doorjamb. The sander preferably includes a block sander.

### BRIEF DESCRIPTION OF DRAWINGS

FIG. 1 depicts a door way for implementing the present invention.

FIG. 2A depicts a doorjamb showing exposed areas where hinges are removed.

FIG. 2B depicts an opposing doorjamb showing an exposed opening that received a bolt from a door knob.

FIG. 3 depicts the components of a doorjamb repair kit according to the present invention.

FIG. 4 depicts a sander used with the door jamb repair kit.

FIG. 5 depicts placement of repair plates onto exposed holes of a doorjamb.

FIG. 6 depicts placement of a single repair plate onto an exposed hole of a door jamb.

FIG. 7 depicts the repaired surface of the doorjamb.

FIG. 8 depicts the repaired surface of the opposing door jamb.

FIG. 9 depicts a glue kit used with the door jamb repair kit.

FIG. 10 shows a hand scraper used with the door jamb repair kit.

### DETAILED DESCRIPTION

The present invention relates to a door jamb repair kit that includes various components to provide an effective toolkit to replace and repair hinges. The kit includes a block sander, hinge plate covers, glue, filler and a scraper to scrape the final finish in the doorjamb. These components are provided in a complete kit to allow for the repair and replacement of a door hinge.

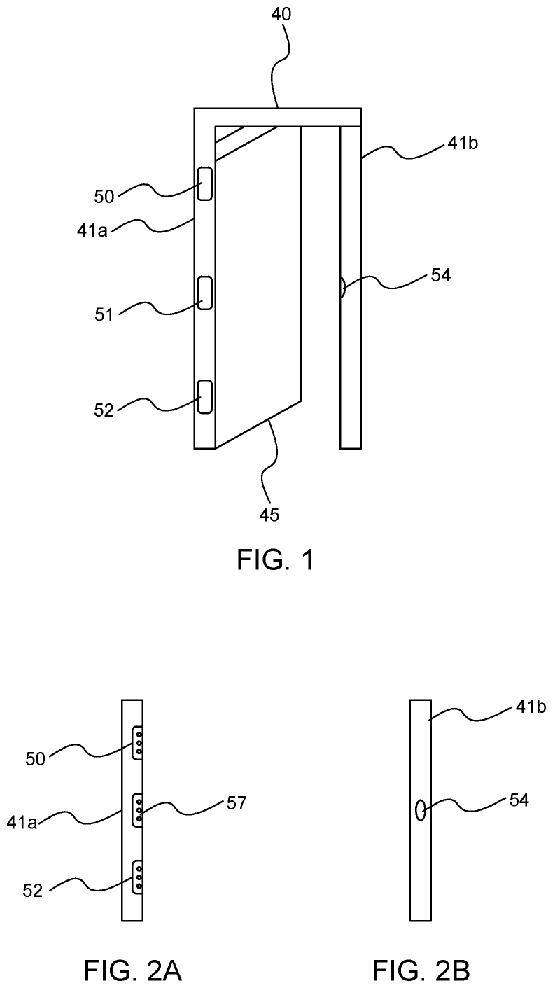

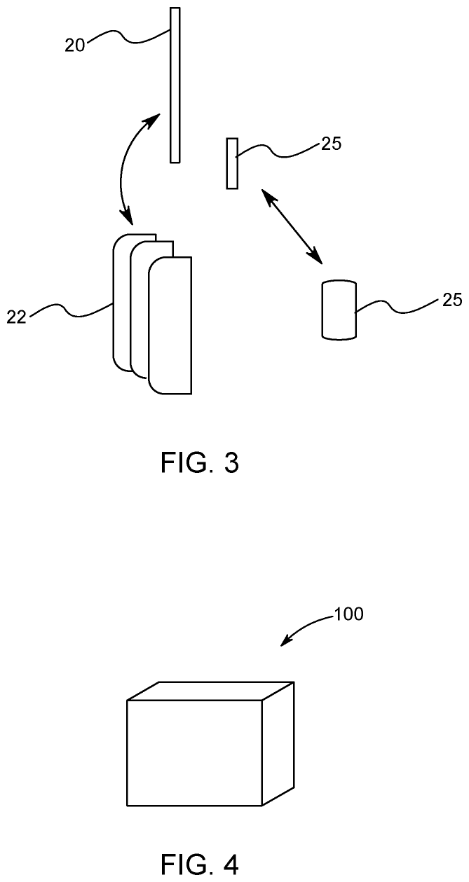

A Doorway 40 is depicted in FIG. 1. The doorway 40 includes a first doorjamb 41a and a second doorjamb 41b along the length of the first doorjamb 41a a series of openings 50, 51, 52 are shown. These openings 50, 51, 52 are associated with hinges that were in placed on this doorjamb 41a to support a door 45, as shown in FIG. 1. Once the door 45 is removed and its hinges are removed, the openings 50, 51, 52 are fully exposed, as shown in FIG. 2A. These exposed openings 50, 51, 52 are therefore a distraction and unattractive unless a door is placed back into the openings through the use of hinges. An opening is also provided for any bolt lock or Doorknob Bolt 54, as shown in Doorjamb 41b. This is more clearly shown in FIG. 2b. These openings require filling or repair if a user desires to remove a door from a doorway. The present invention supplies a kit, as shown in FIGS. 3 and 4, that is used to seal the openings and provide a smooth surface on each and every respective doorjamb.

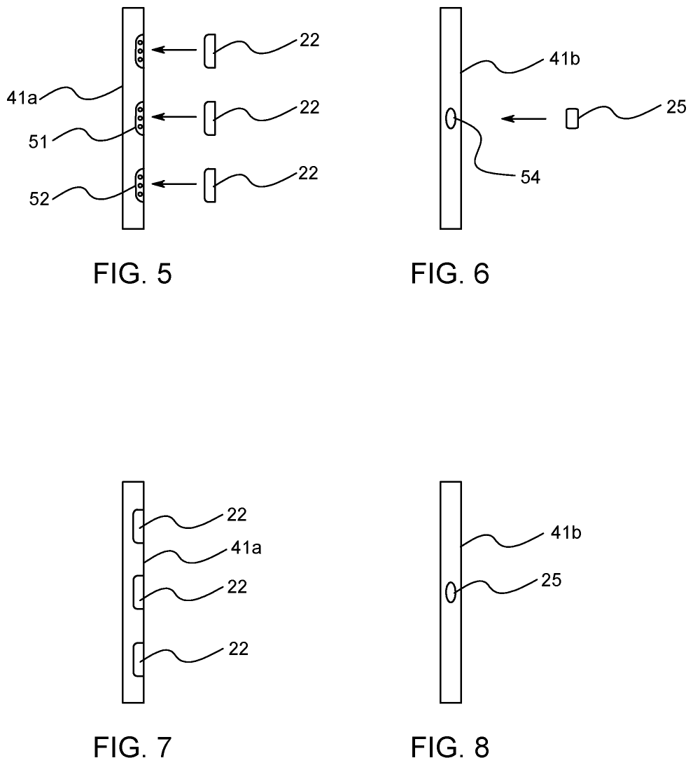

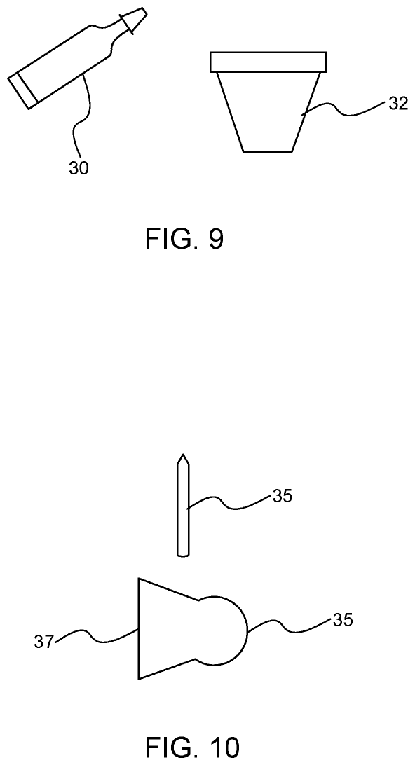

The kit shown in FIG. 3 includes a plate 22 for placement into hinge openings in plate 25, for placement into a bolt opening. Included with the kit is a Block Sander 100, shown in FIG. 4. These plates are placed into the hinge openings, as shown in FIG. 5. Plates 22 are provided to seal the opening and, therefore, are glued into place using glue, as shown in FIG. 9. A scraper 35 with blade edge 37, shown in FIG. 10, is used in conjunction with the glue to smooth out the surface of the doorjamb once the plates are in place, as shown in FIG. 7. So, a user would apply glue to each plate 22 and insert them into the openings along doorjamb 41. The end result is shown in FIG. 7. A similar application is provided for plate 25 that covers the lock opening 54, shown in FIG. 6. This plate 25 is glued into place and provides a smooth surface for doorjamb 41b. Once the plates are glued in place and any excess glue removed, a user has a complete smooth surface for the doorjamb that could be painted or otherwise decorated or finished as desired.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A doorjamb repair kit comprising:
a. a sander;
b. hinge plate covers, each configured for insertion into a doorjamb opening to seal the opening;
c. glue for securing the hinge plate covers in the opening;
d. filler;
e. a scraper to scrape the final finish in the doorjamb.
f. at least one door lock plate cover configured for insertion into a door lock opening to seal the opening, wherein the door lock plate cover is secured in the opening with glue;

2. The doorjamb repair kit according to claim 1, where the sander includes a block sander.
